(19) United States
(12) Patent Application Publication
(10) Pub. No.: US 2014/0124307 A1
(43) Pub. Date: May 8, 2014

(54) POWER TOOL BRAKING DEVICE

(71) Applicant: Florian Esenwein, Leinfelden-Echterdingen (DE)

(72) Inventor: Florian Esenwein, Leinfelden-Echterdingen (DE)

(73) Assignee: Robert Bosch GmbH, Stuttgart (DE)

(21) Appl. No.: 14/004,543

(22) PCT Filed: Feb. 2, 2012
(86) PCT No.: PCT/EP12/51720

§ 371 Date: Nov. 25, 2013

(30) Foreign Application Priority Data
Mar. 18, 2011 (DE) 10 2011 005 812.5

(51) Int. Cl. B24B 23/02; B25F 5/00; B24B 47/26

(52) U.S. Cl. CPC B24B 23/02; B24B 47/26; B25F 5/001
USPC 188/180

(57) ABSTRACT

A power tool braking device of a portable power tool includes at least one braking unit configured to brake a movement of a working tool at least in one operating mode. The at least one braking unit includes at least one rolling-contact element configured to activate at least one braking mode of the at least one braking unit.

### PRIOR ART

There is already known from DE 195 10 291 C2 a power-tool braking device of a portable power tool that has a braking unit provided to brake a motion of a working tool, at least in one operating mode.

### DISCLOSURE OF THE INVENTION

The invention is based on a power-tool braking device, in particular hand-held power-tool braking device, of a portable power tool, comprising at least one braking unit provided to brake a motion of a working tool, at least in one operating mode.

It is proposed that the braking unit have at least one rolling element, which is provided to activate at least one braking mode of the braking unit. A “portable power tool” is to be understood here to mean, in particular, a power tool, in particular a hand-held power tool, that can be transported by an operator without the use of a transport machine. The portable power tool has, in particular, a mass of less than 50 kg, preferably less than 20 kg, and particularly preferably less than 10 kg. The braking unit is preferably provided to brake a rotational motion of the working tool. The braking unit in this case is preferably provided to reduce a speed, in particular a rotational speed, of the working tool, by means of a direct contact of at least two components, as a result of conversion of energy of motion into thermal energy. The braking unit is preferably provided to brake the working tool, when the braking unit is in a braking mode, starting from a working speed, in a period, in particular, greater than 0.1 s, preferably greater than 0.5 s, and particularly preferably less than 3 s, in particular to a speed that is less than 50% of the working speed, preferably less than 20% of the working speed, and particularly preferably to a speed of 0 m/s. A “rolling element” is to be understood here to mean, in particular, an element realized so as to be rotationally symmetrical, at least about an axis, in particular a rotation axis. In particular, the rolling element is provided, in at least one operating state, to roll with at least one surface, in particular a circumferential surface, on a surface of a component as a result of a rotational motion about the rotation axis. Preferably, the rolling element is realized as a cylinder. It is also conceivable, however, for the rolling element to be realized as a ball, as a barrel, or as another rotation body considered appropriate by persons skilled in the art. The expression “braking mode” is intended here to define, in particular, an operating state of the braking unit in which a braking force is generated for the purpose of reducing a speed of a moving component, in particular of the working tool. By means of the design of the power-tool braking device according to the invention, a braking mode of the braking unit can be activated through simple design means. A rolling motion, in particular a rolling motion resulting from a centrifugal force, of the rolling element, can be used, advantageously, to activate the braking mode.

It is furthermore proposed that the braking unit has at least one driver element, which is provided to move at least one frictional element of the braking unit, at least in the braking mode, by means of a combined action with the rolling element. The driver element is preferably rotatably mounted. Particularly preferably, the frictional element is moved along a circumferential direction by means of the combined action of the driver element and rolling element. Preferably, the frictional element is realized in the form of a circular ring. The frictional element therefore extends along the circumferential direction in an angular range of 360°. It is also conceivable, however, for the frictional element to be of another design considered appropriate by persons skilled in the art. In a mounted state, the circumferential direction preferably runs in a plane that extends at least substantially perpendicularly in relation to a rotation axis of the driver element. The expression “substantially perpendicularly” is intended here to define, in particular, an alignment of a direction relative to a reference direction, the direction and the relative direction, in particular as viewed in one plane, enclosing an angle of 90° and the angle having a maximum deviation of, in particular, less than 8°, advantageously less than 5°, and particularly advantageously less than 2°. By means of the design of the portable power tool according to the invention, an energy of motion of the driver element can be used, advantageously, to move the frictional element.

Preferably, the driver element has at least one clamping contour, which is provided to clamp-in the rolling element between the frictional element and the driver element, at least in the braking mode. A “clamping contour” is to be understood here to mean, in particular, a contour of the driver element disposed at least in a portion of an outer contour of the driver element that runs along the circumferential direction, and provided, at least in one state, to generate a clamping force for clamping-in the rolling element, in particular by means of a combined action with the frictional element. Particularly preferably, the clamping contour is disposed on a radial extension of the driver element. The radial extension extends, at least substantially perpendicularly in relation to the rotation axis of the driver element, in a direction that faces away from the driver element. By means of clamping-in of the rolling element, a motion of the frictional element, resulting from frictional force, can be achieved through simple design means.

Advantageously, the clamping contour is realized in the form of a ramp. “In the form of a ramp” is to be understood here to mean, in particular, a geometric form of the clamping contour that, starting from a start point, has a mathematically defined slope along a distance in the direction of an end point, at least as viewed in a plane that comprises the start point and the end point. Particularly preferably, the start point, as viewed along a direction running at least substantially perpendicularly in relation to the rotation axis of the driver element, in comparison with a distance of the end point from the rotation axis, is at a lesser distance from the rotation axis. Advantageously, a direction along which the rolling element moves, at least for the purpose of activating the braking mode, can be defined by the clamping contour. Moreover, clamping-in of the rolling element, when in the braking mode, between the frictional element and the driver element can be realized through simple design means.

It is additionally proposed that the frictional element have a frictional extension that, when in a mounted state, is disposed at least partially along an axial direction, between at least two braking elements of the braking unit. Preferably, the frictional extension extends, at least substantially perpendicularly in relation to the rotation axis of the driver element, in a direction that faces away from the frictional element. Preferably, the frictional extension extends, along the circumferential direction, along an entire circumference of the frictional element. It is also conceivable, however, for the frictional extension to be of another design considered appropriate by persons skilled in the art. The axial direction runs, advantageously, at least substantially parallelwise in relation to the rotation axis of the driver element. “Substantially parallelwise” is intended here to mean, in particular, an alignment of a direction relative to a reference direction, in particular in one plane, the direction deviating from the reference direction by, in particular, less than 8°, advantageously less than 5°, and particularly advantageously less than 2°. By means of the design according to the invention, an energy of motion of the frictional element, and consequently of the driver element, can be advantageously converted into a thermal energy. This advantageously makes it possible to achieve braking of the driver element, in particular upon switch-off of the portable power tool.

Preferably, the braking unit has at least one spring element, which is provided to bias at least one braking element of the braking unit in the direction of the frictional element. A “spring element” is to be understood to mean, in particular, a macroscopic element having at least one extent that, in a normal operating state, can be varied elastically by at least 10%, in particular by at least 20%, preferably by at least 30%, and particularly advantageously by at least 50% and that, in particular, generates a counter-force, which is dependent on the variation of the extent and preferably proportional to the variation and which counteracts the variation. An “extent” of an element is to be understood to mean, in particular, a maximum distance of two points of a perpendicular projection of the element on to a plane. A “macroscopic element” is to be understood to mean, in particular, an element having an extent of at least 1 mm, in particular of at least 5 mm, and preferably of at least 10 mm.

The braking element in this case has at least one brake lining, which is fixed to the braking element. The brake lining may be fixed to the braking element by means of a form-fitting, force-fitting and/or materially bonded connection, such as, for example, an adhesive connection, a riveted connection, a screwed connection or a connection produced by means of a sintering operation or by means of an injection molding method, etc. The brake lining in this case may be realized as a sintered brake lining, as an organic brake lining, as a brake lining made of carbon, as a brake lining made of ceramic, or as another brake lining considered appropriate by persons skilled in the art. The frictional element, in particular the frictional extension, for the purpose of achieving a material pairing suitable for generating an advantageous braking force, when in a braking mode, by means of a combined action with the braking element, may be composed of sintered bronze, steel, nitrided steel, aluminum or another surface-treated steel and/or metal. Through simple design means, an action of a frictional force between the frictional element and the braking element can be set by means of the spring element of the braking unit.

It is additionally proposed that the braking unit have at least one actuating element provided to move the rolling element as a result of a relative motion between the actuating element and a driver element of the braking unit, at least in one operating mode. Particularly preferably, the rolling element is moved by means of the actuating element for the purpose of releasing the braking mode of the braking unit. Advantageously, therefore, a release operation can be initiated as a result of a relative motion. Advantageously, it is possible to dispense with additional electrical and/or electronic components for initiating a release operation.

Advantageously, the power-tool braking device comprises
at least one output unit, which comprises at least one output element, to which the actuating element is connected in a rotationally fixed manner. An “output unit” is to be understood here to mean, in particular, a unit that can be driven by means of a drive unit of the portable power tool and that transmits forces and/or torques, generated by the drive unit, to a working tool. Particularly preferably, the output unit is realized as a bevel gear transmission. In this case, the output element is preferably realized as a ring gear. The actuating element is preferably disposed on a side of the ring gear that faces away from a toothing of the ring gear. Particularly preferably, the actuating element is connected to the ring gear in a rotationally fixed manner. The actuating element in this case can be integral with the ring gear. “Integral with” is to be understood here to mean, in particular, connected at least in a materially bonded manner, for example by a welding process, an adhesive bonding process, an injection process and/or by another process considered appropriate by persons skilled in the art, and/or, advantageously, formed in one piece, such as, for example, by being produced from a casting and/or by being produced in a single- or multi-component injection process and, advantageously, from a single blank. It is also conceivable, however, for the actuating element to be connected to the ring gear in a form-fitting and/or force-fitting matter, such as, for example, by means of a screwed connection, etc. A motion of the rolling element by means of the actuating element, in dependence on a motion of the output element, can be achieved through simple design means. Advantageously, therefore, in the case of an interruption of a transmission of torque to the output element, a relative motion of the output element, relative to an output shaft of the output unit, in particular a spindle, can be used to move the braking element.

In addition, in a further alternative design, it is conceivable for the power-tool braking device unit to be realized as a mountable module. The expression “mountable module” is intended here to define, in particular, an assembly of a unit whereby a plurality of components are pre-mounted and the unit can be mounted as a whole in a complete system, in particular in the portable power tool. The mountable module preferably has at least one fastening element, which is provided to detachably connect the mountable module to the complete system. Advantageously, the mountable module can be demounted from the complete system, in particular, with fewer than 10 fastening elements, preferably with fewer than 8 fastening elements, and particularly preferably with fewer than 5 fastening elements. Particularly preferably, the fastening elements are realized as screws. It is also conceivable, however, for the fastening elements to be realized as other elements, considered appropriate by persons skilled in the art, such as, for example, as quick-action clamping elements, fastening elements that can be actuated without tools, etc. Preferably, at least one function of the mountable module can be realized when demounted from the complete system. Particularly preferably, the mountable module can be demounted by an end user. The mountable module is therefore realized as an exchangeable unit, which can be replaced by a further mountable module, such as, for example, in the case of a defect of the mountable module or an expansion of function and/or change of function of the complete system. The design of the braking unit as a mountable module makes it possible, advantageously, to achieve a wide spectrum of application of the power-tool braking device.

Moreover, integration into already existing portable power tools can be achieved through simple design means. Furthermore, advantageously, production costs can be kept low as a result.

The invention is additionally based on a portable power tool, in particular a portable hand-held power tool, having a power-tool braking device according to the invention, in particular having a hand-held power-tool braking device. The portable power tool in this case may be realized as an angle grinder, a drill, a hand-held circular saw, a chipping hammer and/or a hammer drill, etc. Advantageously, a safety function can be achieved for an operator of the portable power tool.

The power-tool braking device according to the invention and/or the portable power tool according to the invention in this case is/are not intended to be limited to the application and embodiment described above. In particular, the power-tool braking device according to the invention and/or the portable power tool according to the invention, for the purpose of implementing a functioning mode described herein, can have a number of individual elements, components and units that differs from a number stated herein.

### DRAWING

Further advantages are given by the following description of the drawing. The drawing shows exemplary embodiments of the invention. The drawing, the description and the claims contain numerous features in combination. Persons skilled in the art will also expediently consider the features individually and combine them to create appropriate further combinations.

In the drawing:

FIG. 1 shows a power tool according to the invention having a power-tool braking device according to the invention, in a schematic representation,

FIG. 2 shows a sectional view of a transmission housing, of the portable power tool according to the invention and of the power-tool braking device according to the invention, that has been demounted from a motor housing of the portable power tool according to the invention, in a schematic representation,

FIG. 3 shows a further sectional view of the transmission housing and of the power-tool braking device according to the invention, in a non-braked state, in a schematic representation,

FIG. 4 shows a further sectional view of the transmission housing and of the power-tool braking device according to the invention, in a braked state, in a schematic representation,

FIG. 5 shows a detail view of a braking unit of the power-tool braking device according to the invention, in a schematic representation,

FIG. 6 shows a detail view of a mounting plate of the braking unit of the power-tool braking device according to the invention, in a schematic representation,

FIG. 7 shows a detail view of a driver element of the braking unit of the power-tool braking device according to the invention, in a schematic representation,

FIG. 8 shows a detail view of a driver element having, rolling elements disposed thereon, and of a frictional element of the braking unit having, disposed thereon, braking elements of the braking unit of the power-tool braking device according to the invention, in a schematic representation,

FIG. 9 shows a sectional view of an alternative embodiment of a power-tool braking device according to the invention, in a schematic representation,

FIG. 10 shows a sectional view of a further alternative embodiment of a power-tool braking device according to the invention, in a schematic representation,

FIG. 11 shows a detail view of an arrangement of individual components of the alternative power-tool braking device according to the invention, in a schematic representation, and

FIG. 12 shows a further detail view of an arrangement of individual components of the alternative power-tool braking device according to the invention, in a schematic representation.

### DESCRIPTION OF THE EXEMPLARY EMBODIMENTS

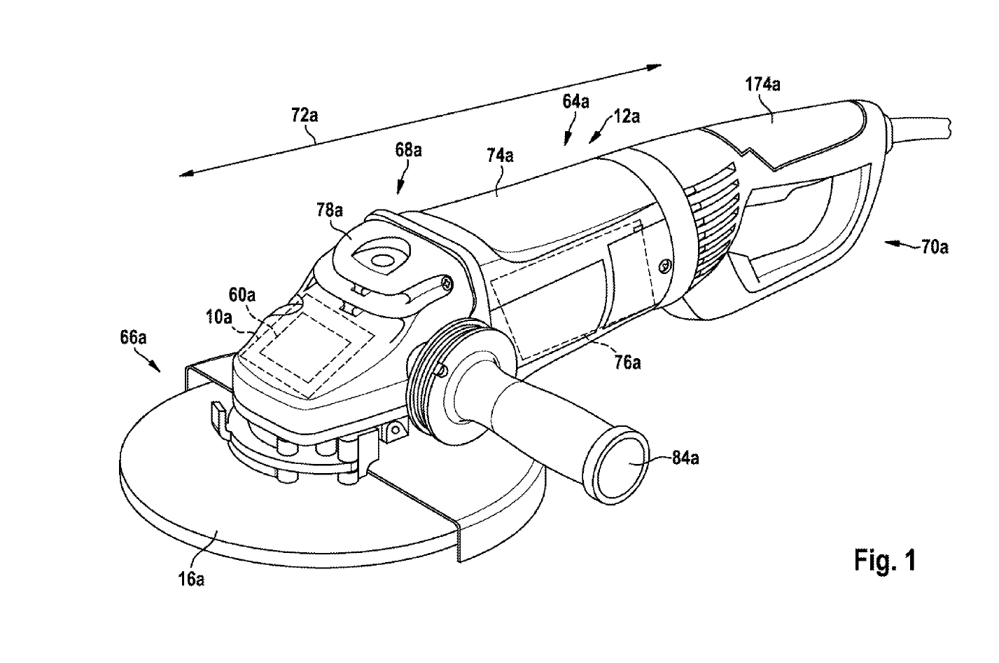

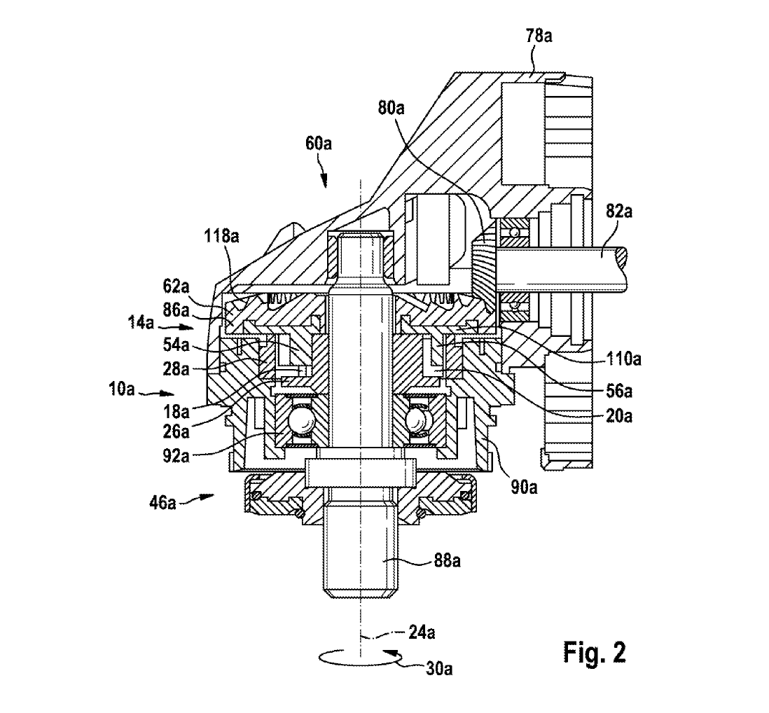

FIG. 1 shows a portable power tool 12a, realized as an angle grinder 64a, having a power-tool braking device 10a. The angle grinder 64a comprises a protective hood unit 66a, a power-tool housing 68a and a main handle 174a. From the power-tool housing 68a, the main handle 174a extends out, on a side 70a of the power-tool housing 68a that faces away from a working tool 16a, in a direction that faces away from the power-tool housing 68a and that runs at least substantially parallelwise in relation to a direction of main extent 72a of the angle grinder 64a. The working tool 16a in this case is realized as an abrasive disc. It is also conceivable, however, for the working tool 16a to be realized as a parting or polishing disc. The power-tool housing 68a comprises a motor housing 74a, for accommodating a drive unit 76a of the angle grinder 64a, and a transmission housing 78a, for accommodating an output unit 60a of the power-tool braking device 10a. The drive unit 76a is provided to drive the working tool 16a in rotation, via the output unit 60a. The output unit 60a is connected to the drive unit 76a, via a drive element 80a of the drive unit 76a that can be driven in rotation in a manner already known to persons skilled in the art. The drive element 80a is realized as a pinion gear, which is connected in a rotationally fixed manner to an armature shaft 82a of the drive unit 76a (FIG. 2). An ancillary handle 84a is additionally disposed on the transmission housing 78a. The ancillary handle 84a extends transversely in relation to the direction of main extent 72a of the angle grinder 64a.

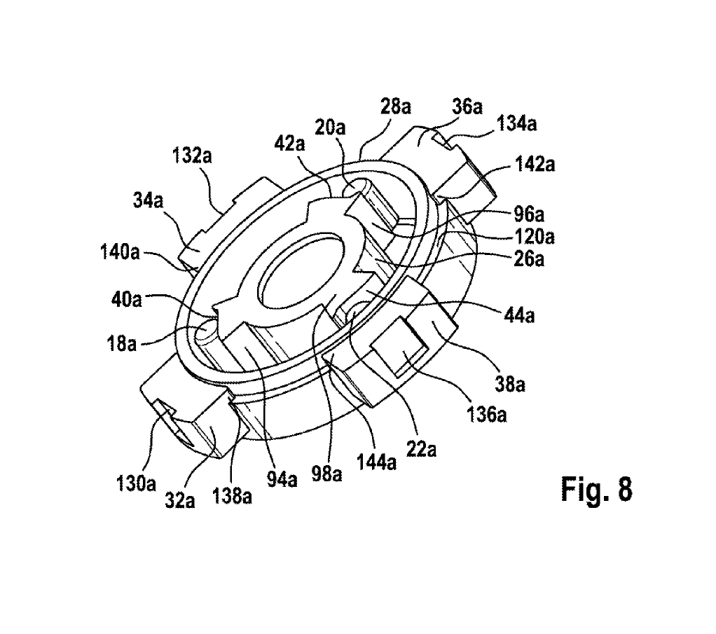

The power-tool braking device 10a is disposed on the transmission housing 78a of the angle grinder 64a (FIG. 2). A portion of the power-tool braking device 10a extends into the transmission housing 78a. A portion of the power-tool braking device 10a is therefore enclosed by the transmission housing 78a. The power-tool braking device 10a comprises a braking unit 14a, which is provided, when the braking unit 14a is in a braking mode, to brake a motion of the working tool 16a that is fixed to a spindle 88a of the output unit 60a. The braking unit 14a in this case has three rolling elements 18a, 20a, 22a, which are provided to activate the braking mode of the braking unit 14a. The rolling elements 18a, 20a, 22a are cylindrical in form (FIG. 8). In addition, the braking unit 14a comprises the output unit 60a, which has an output element 62a. The output element 62a is realized as a ring gear 86a. It is also conceivable, however, for the output element 62a to be of another design considered appropriate by persons skilled in the art. The ring gear 86a is disposed, by means of a clearance fit, on a rotatably mounted output shaft of the output unit 60a. The output shaft of the output unit 60a in this case is constituted by the spindle 88a. The output unit 60a additionally comprises a bearing flange 90a, and a bearing element 92a, disposed in the bearing flange 90a, for rotatably mounting the spindle 88a. The bearing flange 90a is detachably connected to the transmission housing 78a by means of fastening elements (not represented in greater detail here) of the output unit 60a.

For the purpose of performing work on a workpiece, the working tool 16a is connected to the spindle 88a in a rotationally fixed manner by means of a fastening element (not represented in greater detail here). When the angle grinder 64a is in operation, therefore, the working tool 16a can be driven in rotation. The power-tool braking device 10a additionally has a run-off safety unit 46a, which is provided to prevent the working tool 16a, and/or the fastening element for fastening the working tool 16a, from running off the spindle 80a when the braking unit 14a of the power-tool braking device 10a is in a braking mode. The run-off safety unit 46a in this case is realized as a receiving flange, which is connected to the spindle 88a in a rotationally fixed manner by means of a form-fit. It is also conceivable, however, for the run-off safety unit 46a to be connected to the spindle 88a in a rotationally fixed manner by means of other types of connection considered appropriate by persons skilled in the art.

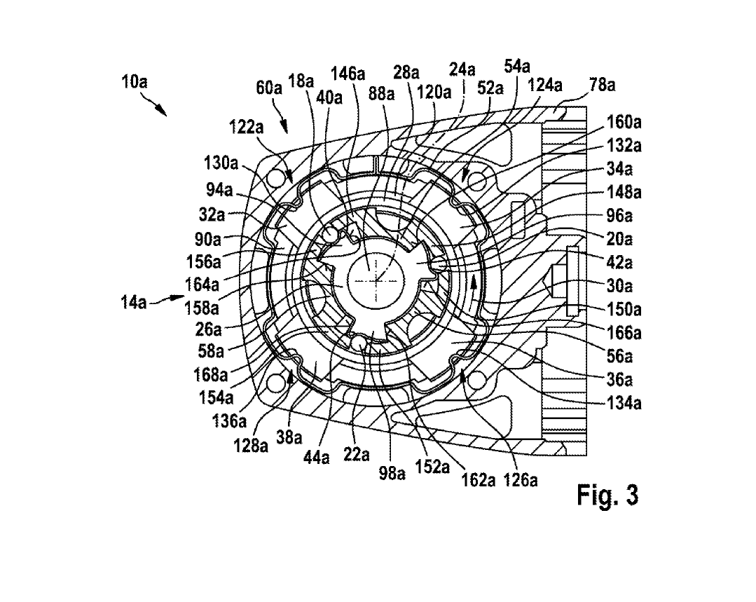

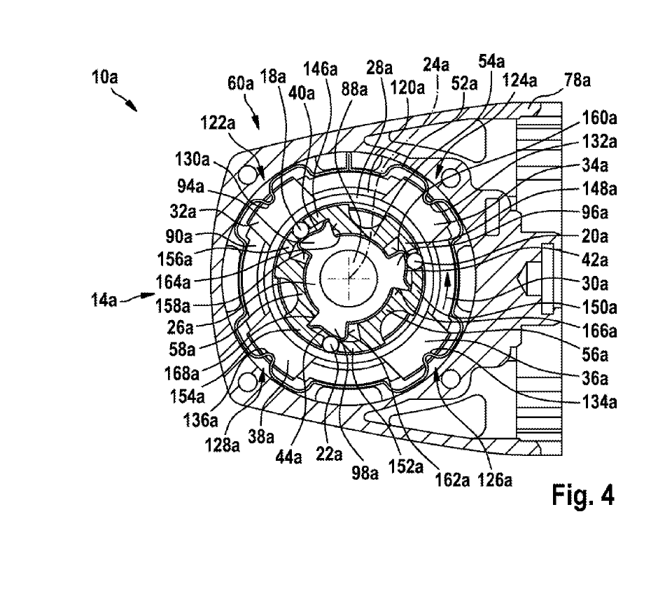

Furthermore, the braking unit 14a comprises a driver element 26a, which is provided to move a frictional element 28a of the braking unit 14a, when in the braking mode, by means of a combined action with the rolling elements 18a, 20a, 22a (FIGS. 3 and 4). The driver element 26a is connected to the spindle 88a in a rotationally fixed manner. The driver element 26a additionally has three clamping contours 40a, 42a, 44a, which are provided, in the braking mode, to clamp-in the rolling elements 18a, 20a, 22a between the frictional element 28a and the driver element 26a, as viewed along a direction running at least substantially perpendicularly in relation to a rotation axis 24a of the spindle 88a. The rolling elements 18a, 20a, 22a in this case are disposed in the region of the clamping contours 40a, 42a, 44a. Owing to the rotationally fixed connection of the driver element 26a and of the spindle 88a, a rotation axis of the driver element 26a, in a mounted state, runs coaxially with the rotation axis 24a of the spindle 88a. The clamping contours 40a, 42a, 44a are each realized in the form of a ramp. In addition, the clamping contours 40a, 42a, 44a are each disposed on a radial extension 94a, 96a, 98a of the driver element 26a (FIG. 7). The radial extensions 94a, 96a, 98a, starting from the driver element 26a, extend along the direction that runs at least substantially perpendicularly in relation to the rotation axis 24a of the spindle 88a, in the direction of the frictional element 28a. The radial extensions 94a, 96a, 98a are disposed at a distance from the frictional element 28a, along the direction that runs at least substantially perpendicularly in relation to the rotation axis 24a. The radial extensions 94a, 96a, 98a in this case are integral with the driver element 26a. It is also conceivable, however, for the radial extensions 94a, 96a, 98a to be connected to the driver element 26a by means of a form-fitting and/or force-fitting connection. The clamping contours 40a, 42a, 44a are each disposed on a side of the radial extensions 94a, 96a, 98a that faces toward the frictional element 28a. The radial extensions 94a, 96a, 98a are disposed on the driver element 26a, being uniformly distributed along a circumferential direction 30a. The circumferential direction 30a runs in a plane that extends at least substantially perpendicularly in relation to the rotation axis 24a of the spindle 88a.

The frictional element 28a is realized in the form of a circular ring. In addition, the frictional element 28a is at least partially surrounded, along the circumferential direction 30a, by four braking elements 32a, 34a, 36a, 38a of the braking unit 14a. The braking elements 32a, 34a, 36a, 38a are uniformly spaced apart from each other along the circumferential direction 30a. In this case, each two braking elements 32a, 34a, 36a, 38a that directly succeed each other along the circumferential direction 30a are offset by 90° in relation to each other. The braking elements 32a, 34a, 36a, 38a each have a brake lining (not represented in greater detail here), on a side of the respective braking elements 32a, 34a, 36a, 38a that faces toward the frictional element 28a. Furthermore, the frictional element 28a has a guide extension 120a that, starting from the frictional element 28a, extends along the direction that runs at least substantially perpendicularly in relation to the rotation axis 24a of the spindle 88a, in the direction of the braking elements 32a, 34a, 36a, 38a (FIG. 8). The guide extension 120a is provided to guide the frictional element 28a axially in the bearing flange 90a of the output unit 60a. The braking elements 32a, 34a, 36a, 38a in this case each have a step-shaped shoulder 138a, 140a, 142a, 144a (FIG. 8), against which the guide extension 120a can strike in the case of an axial motion of the frictional element 28a in the direction of the ring gear 86a. For the purpose of guiding the frictional element 28a radially in the bearing flange 90a, the bearing flange 90a has a groove-shaped recess (not represented in greater detail here), in which the frictional element 28a is disposed with clearance. The frictional element 28a is therefore disposed so as to be movable in the bearing flange 90a, along the circumferential direction 30a.

Furthermore, the braking unit 14a has a spring element 52a, which is provided to bias the braking elements 32a, 34a, 36a, 38a of the braking unit 14a in the direction of the frictional element 28a. The spring element 52a is realized as an annular spring. The spring element 52a additionally comprises retaining regions 122a 124a, 126a, 128a. The retaining regions 122a 124a, 126a, 128a each engage, respectively, in a positioning recess 130a, 132a, 134a, 136a of the corresponding braking element 32a, 34a, 36a, 38a, for the purpose of positioning the braking elements 32a, 34a, 36a, 38a. The braking elements 32a, 34a, 36a, 38a therefore bear against the frictional element 28a, as a result of a spring force of the spring element 52a on a side of the frictional element 28a that faces toward the braking elements 32a, 34a, 36a, 38a.

The braking unit 14a additionally has three actuating elements 54a, 56a, 58a, which are provided, when in an operating mode, to move the rolling element 18a, 20a, 22a as a result of a relative motion between the actuating elements 54a, 56a, 58a and the driver element 26a of the braking unit 14a (FIGS. 3 and 4). When in the braking mode, and when in a release mode, in which an action of braking forces upon the driver element 26a, the spindle 88a and, consequently, upon the working tool 16a, is prevented, the rolling elements 18a, 20a, 22a are moved by means of the actuating elements 54a, 56a, 58a. For this purpose, the actuating elements 54a, 56a, 58a each have two actuating arms 146a, 148a, 150a, 152a, 154a, 156a. In this case, respectively one of the actuating arms 146a, 148a, 150a, 152a, 154a, 156a of the respective actuating element 54a, 56a, 58a extends along the circumferential direction 30a, and respectively one of the actuating arms 146a, 148a, 150a, 152a, 154a, 156a of the respective actuating element 54a, 56a, 58a extends contrary to the circumferential direction 30a. The actuating elements 54a, 56a, 58a are connected in a rotationally fixed manner to the output element 62a that is realized as a ring gear 86a. The actuating elements 54a, 56a, 58a in this case are disposed at a distance from the frictional element 28a, along the direction running substantially perpendicularly in relation to the rotation axis 24a (FIGS. 3 and 4).

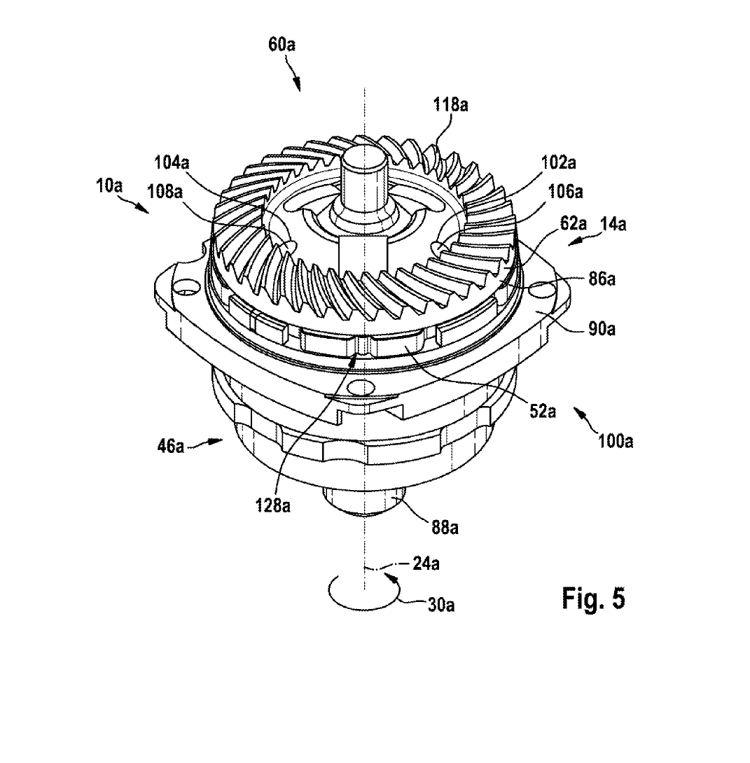

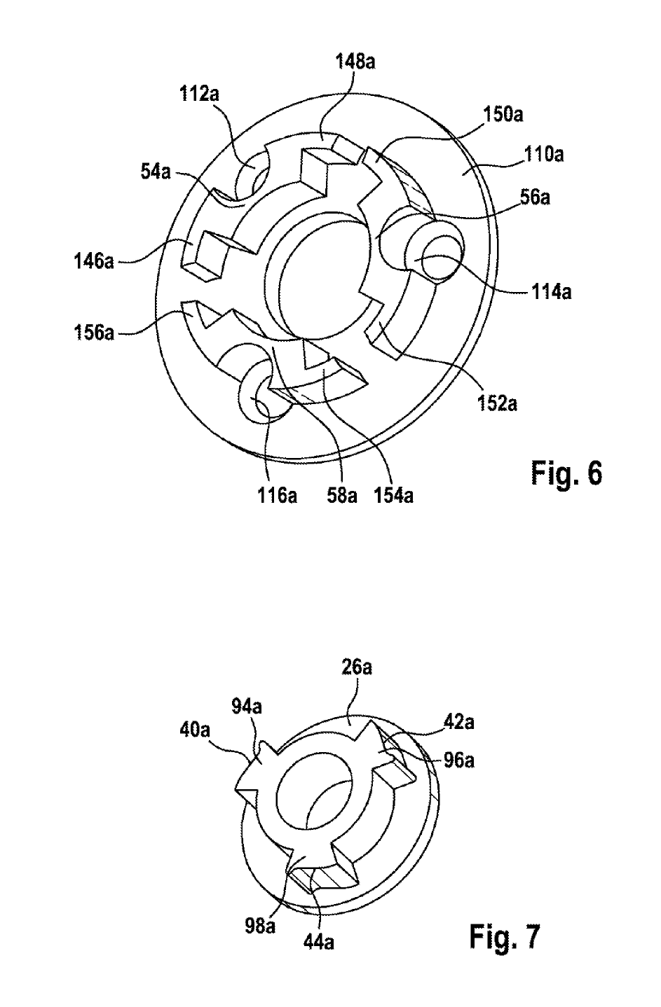

The ring gear 86a has three recesses 102a, 104a (only two are represented in FIG. 5), realized as threaded bores, which are provided to receive fastening elements 106a, 108a of the braking unit 14a (only two are represented in FIG. 5), which are realized as screws, for fastening a mounting plate 110a of the braking unit 14a. The mounting plate 110a in this case has three recesses 112a, 114a, 116a, in which the fastening elements 106a, 108a are disposed when in a mounted state. The actuating elements 54a, 56a, 58a are integral with the mounting plate 110a (FIG. 6). Moreover, when in a mounted state, the actuating elements 54a, 56a, 58a, as viewed along the circumferential direction 30a, are disposed uniformly along the circumferential direction 30a, on the mounting plate 110a. The mounting plate 110a, when in a mounted state, is disposed on a side of the ring gear 86a that faces away from a toothing 118a of the ring gear 86a.

When the angle grinder 64a is put into operation, the ring gear 86a is driven by means of the drive element 80a of the drive unit 76a, which drive element is realized as a pinion gear. The ring gear 86a in this case first moves relative to the driver element 26a that is connected in a rotationally fixed manner to the spindle 88a, until the actuating elements 54a, 56a, 58a each come to bear against a driving face 158a, 160a, 162a of the driver element 26a that faces toward the respective actuating element 54a, 56a, 58a. The rolling elements 18a, 20a, 22a are moved, respectively, by means of an actuating arm 146a, 150a, 154a of the respective actuating element 54a, 56a, 58a, out of a clamping position between the frictional element 28a and the driver element 28a, along the clamping contours 40a, 42a, 44a (FIG. 3). The braking unit 14a is thus brought into the release mode. The movement along the clamping contours 40a, 42a, 44a moves the rolling elements 18a, 20a, 22a away from the frictional element 28a. As soon as the actuating elements 54a, 56a, 58a bear against the driving faces 158a, 160a, 162a and the rolling elements 18a, 20a, 22a have been moved away from the frictional element 28a, the braking unit 14a is in the release mode. When the braking unit 14a is in the release mode, the rolling elements 18a, 20a, 22a are disposed at a lesser distance from the spindle 88a, as viewed along the direction running substantially perpendicularly in relation to the rotation axis 24a, than a distance of the rolling elements 18a, 20a, 22a from the spindle 88a when the braking unit 14a is in the braking mode. When the braking unit 14a is in the release mode, therefore, direct contact between the rolling elements 18a, 20a, 22a and the frictional element 28a is prevented (FIG. 3). For this purpose, the actuating arms 146a, 148a, 150a, 152a, 154a, 156a have retaining faces that, as far as possible, prevent a motion of the rolling elements 18a, 20a, 22a in the direction of the frictional element 28a and press the rolling elements 18a, 20a, 22a against the clamping contours 40a, 42a, 44a.

Owing to the fact that the actuating elements 54a, 56a, 58a bear against the driving faces 158a, 160a, 162a, and the fact that the rolling elements 18a, 20a, 22a press against the clamping contours 40a, 42a, 44a, a rotary motion of the ring gear 86a is transmitted to the driver element 26a, and consequently to the spindle 88a. The ring gear 86a, the driver element 26a, the rolling elements 18a, 20a, 22a pressed against the clamping contours 40a, 42a, 44a, and the spindle 88a rotate jointly about the rotation axis 24a of the spindle 88a. Consequently, the rolling elements 18a, 20a, 22a rotate relative to the frictional element 28a. Owing to the combined action of the ring gear 86a, driver element 26a and spindle 88a, the working tool 16a, which is connected to the spindle 88a in a rotationally fixed manner, is driven in rotation. Work can thus be performed on a workpiece by means of the working tool 16a.

Upon switch-off of the angle grinder 64a, the drive element 80a, realized as a pinion gear, is braked by the drive unit 76a. The working tool 16a, which is fastened on the spindle 88a, continues to rotate because of a mass inertia. Consequently, the spindle 88a likewise continues to be rotated about the rotation axis 24a. The drive element 80a brakes the ring gear 86a. As a result of this, the ring gear 86a is rotated about the rotation axis 24a, relative to the driver element 26a, until, as a result of the relative motion, the actuating elements 54a, 56a, 58a strike against stop faces 164a, 166a, 168a of the radial extensions 96a, 98a. The stop faces 164a, 166a, 168a are each disposed along the circumferential direction 30a, on a side of the respective radial extension 96a, 98a that faces away from the respective driving face 158a, 160a, 162a (FIG. 4). During the relative motion of the ring gear 86a and driver element 26a, the rolling elements 18a, 20a, 22a are moved along the clamping contours 40a, 42a, 44a, in the direction of the frictional element 28a, as a result of a centrifugal force, and by the respective actuating arms 148a, 152a, 156a. The rolling elements 18a, 20a, 22a continue to move along the clamping contour 40a, 42a, 44a until the rolling elements 18a, 20a, 22a are clamped-in between the frictional element 28a and the clamping contours 40a, 42a, 44a. This results in a force-fit being produced along the circumferential direction 30a, between the driver element 26a and the frictional element 28a. The braking unit 14a is thus in the braking mode.

Owing to the combined action of the driver element 26a, frictional element 28a and the rolling elements 18a, 20a, 22a, together with the driver element 26a, as a result of the mass inertia of the working tool 16a, the frictional element 28a is moved about the rotation axis 24a. The frictional element 28a in this case moves relative to the braking elements 32a, 34a, 36a, 38a. The braking elements 32a, 34a, 36a, 38a thus drag against the side of the frictional element 28a that faces toward the braking elements 32a, 34a, 36a, 38a. As a result of this, a braking force for braking the spindle 88a, and consequently the working tool 16a, is generated by means of a friction between the braking elements 32a, 34a, 36a, 38a and the frictional element 28a. The spindle 88a and the working tool 16a are braked to a standstill. When the angle grinder 64a is put into operation again, the combined action of the actuating elements 54a, 56a, 58a and clamping contours 40a, 42a, 44a results in the braking unit 14a being reliably brought out of the braking mode and into the release mode.

The braking unit 14a, together with the output unit 60a, is realized as a mountable module 100a (FIG. 5). The mountable module 100a thus constitutes the power-tool braking device 10a. The mountable module 100a comprises four fastening elements (not represented here), realized as screws. The screws are provided for detachably connecting the mountable module 100a to the transmission housing 78a. If necessary, an operator can demount the mountable module 100a from the transmission housing 78a. The angle grinder 64a and the power-tool braking device 10a thus constitute a power-tool system. The power-tool system may comprise a further mountable module. The further mountable module may comprise, for example, an output unit realized as a bevel gear transmission. The further mountable module could be mounted on the transmission housing 78a by the operator, for example, as an alternative to the mountable module 100a. An operator therefore has the possibility of equipping the angle grinder 64a with the mountable module 100a that comprises the braking unit 14a and the output unit 60a, or with the further mountable module that comprises an output unit. For an application in which the angle grinder 64a is to be operated separately from the power-tool braking device 10a, an operator can replace the mountable module 100a by the further mountable module of the power-tool system. For this purpose, the operator merely demounts the mountable module 100a from the transmission housing 78a and mounts the further mountable module on the transmission housing 78a.

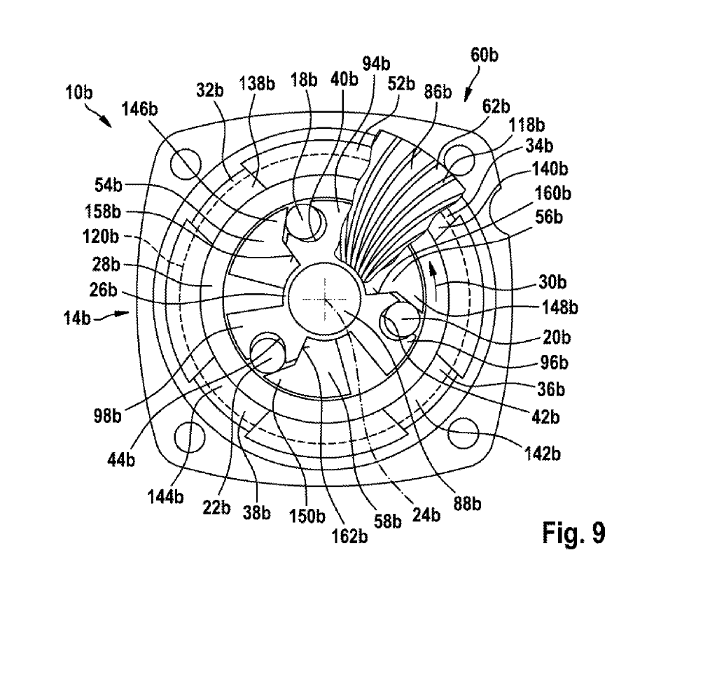

Alternative exemplary embodiments are represented in FIGS. 9 to 12. Components, features and functions that remain substantially the same are denoted by essentially the same references. To differentiate the exemplary embodiments, the letters a to c are appended to the references of the exemplary embodiments. The description that follows is limited essentially to the differences in respect of the first exemplary embodiment, described in FIGS. 1 to 8, and reference may be made to the description of the first exemplary embodiment in FIGS. 1 to 8 in respect of components, features and functions that remain the same.

FIG. 9 shows an alternative power-tool braking device 10b, which can be mounted on a transmission housing of an angle grinder (not represented in greater detail here) that is realized in a manner similar to the angle grinder 64a described in the description of FIGS. 1 to 8. The power-tool braking device 10b comprises a braking unit 14b, which is provided, when in an operating mode, to brake a motion of the working tool (not represented in greater detail here). Furthermore, the power-tool braking device 10b comprises an output unit 60b. The braking unit 14b and the output unit 60b are of a structure that is at least substantially similar to that of the braking unit 14a and output unit 60a described in the description of FIGS. 1 to 8. The braking unit 14b thus has three rolling elements 18b, 20b, 22b, and the output unit 60b has an output element 62b that is realized as a ring gear 86b. The rolling elements 18b, 20b, 22b are provided to activate a braking mode of the braking unit 14b. The braking unit 14b additionally has three actuating elements 54b, 56b, 58b, which are integral with the output element 62b realized as a ring gear 86b. The actuating elements 54b, 56b, 58b have a respective actuating arm 146b, 148b, 150b, which in each case is provided to prevent, as far as possible, a motion of the respective rolling element 18b, 20b, 22b in the direction of a frictional element 28b of the braking unit, and to press the rolling elements 18b, 20b, 22b against clamping contours 40b, 42b, 44b of a driver element 26b of the braking unit 14b. The actuating arms 146b, 148b, 150b are each disposed on the respective actuating element 54b, 56b, 58b, on a side of the actuating element 54b, 56b, 58b that faces toward the respective clamping contour 40b, 42b, 44b. Reference may be made to the description of FIGS. 1 to 8 in respect of a mode of functioning of the braking unit 14b and of the output unit 60b.

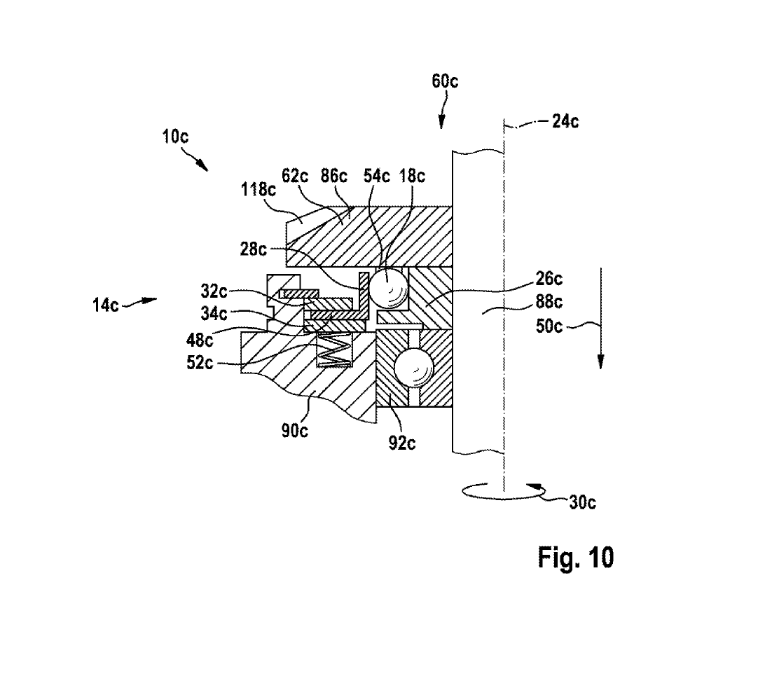

FIG. 10 shows a further alternative power-tool braking device 10c, which can be mounted on a transmission housing of an angle grinder (not represented in greater detail here) that is realized in a manner similar to the angle grinder 64a described in the description of FIGS. 1 to 8. The power-tool braking device 10c comprises a braking unit 14c, which is provided, when in an operating mode, to brake a motion of the working tool (not represented in greater detail here). Furthermore, the power-tool braking device 10c comprises an output unit 60c. The output unit 60c is of a structure that is at least substantially similar to that of the output unit 60a described in the description of FIGS. 1 to 8. The output unit 60c thus has an output element 62c realized as a ring gear 86c. The output element 62c realized as a ring gear 86c is disposed, by means of a clearance fit, on an output shaft of the output unit 60c, which output shaft is rotatably mounted and realized as a spindle 88c.

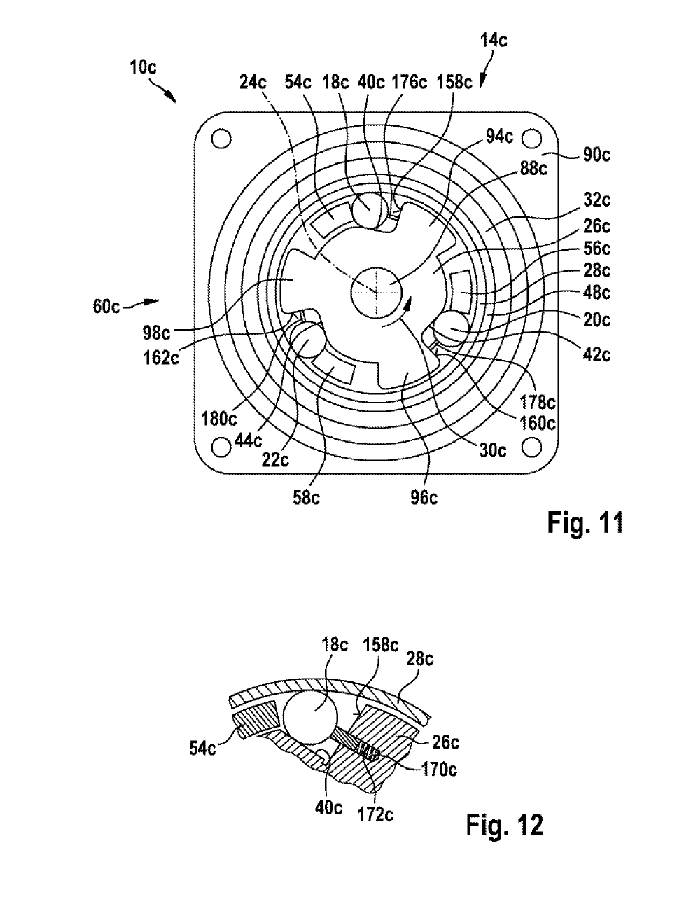

The braking unit 14c has three rolling elements 18c, 20c, 22c, which are provided to activate a braking mode of the braking unit 14c (FIG. 11). The rolling elements 18c, 20c, 22c are realized as balls. The braking unit 14c additionally has three actuating elements 54c, 56c, 58c. The actuating elements 54c, 56c, 58c are realized in the form of studs. The actuating elements 54c, 56c, 58c in this case have a rectangular cross section, as viewed in a plane running at least substantially in relation to a rotation axis 24c of the spindle 88c. The actuating elements 54c, 56c, 58c are connected to the ring gear 86c by means of a form-fitting and/or force-fitting connection. It is also conceivable, however, for the actuating elements 54c, 56c, 58c to be integral with the ring gear 86c.

The braking unit 14c additionally has a driver element 26c, which is provided to move a frictional element 28c of the braking unit 14c, when in the braking mode, by means of a combined action with the rolling elements 18c, 20c, 22c. The driver element 26c in this case has three clamping contours 40c, 42c, 44c, which are provided to clamp-in the rolling elements 18c, 20c, 22c between the frictional element 28c and the driver element 26c, when in the braking mode. The rolling elements 18c, 20c, 22c are disposed in the region of the clamping contours 40c, 42c, 44c. For the purpose of driving the driver element 26c in rotation when the angle grinder, not represented here, is put into operation, the rolling elements 18c, 20c, 22c are moved along the clamping contours 40c, 42c, 44c, away from the frictional element 28c, by means of the actuating elements 54c, 56c, 58c, until the rolling elements 18c, 20c, 22c bear against driving faces 158c, 160c, 162c of radial extensions 94c, 96c, 98c of the driver element 26c. The actuating elements 54c, 56c, 58c thus transmit a torque to the driver element 26c, via the rolling elements 18c, 20c, 22c. The radial extensions 94c, 96c, 98c are disposed, spaced apart from the frictional element 28c, along a direction running at least substantially perpendicularly in relation to the rotation axis 24c. When the braking unit 14c is in a release mode, therefore, the driver element 26c and the rolling elements 18c, 20c, 22c, together with the actuating elements 54c, 56c, 58c disposed on the ring gear 86c, can move relative to the frictional element 28c.

The frictional element 28c has a frictional extension 48c that, when in a mounted state, is disposed at least partially along an axial direction 50c, between two braking elements 32c, 34c of the braking unit 14c. The axial direction 50c runs at least substantially parallelwise in relation to the rotation axis 24c of the spindle 88c. The frictional extension 48c extends, starting from the frictional element 28c, along the direction running at least substantially perpendicularly in relation to the rotation axis 24c, in the direction of a bearing flange 90c of the output unit 60c. The braking elements 32c, 34c are disposed in the bearing flange 90c, being fixed to the housing. By means of a spring element 52c of the braking unit 14c, one of the braking elements 32c, 34c is biased in the direction of the frictional extension 48c that is integral with the frictional element 28c.

The braking unit 14c furthermore has three positioning springs 170c (of which only one is represented in FIG. 12), which are provided to bias the rolling elements 18c, 20c, 22c in the direction of the frictional element 28c. The positioning springs 170c are each disposed in a recess 172c in the radial extensions 94c, 96c, 98c (only one recess is represented in FIG. 12). For the purpose of reliably guiding the rolling elements 18c, 20c, 22c in a motion by means of the positioning springs 170c, the braking unit 14c has guide extensions 176c, 178c, 180c that, when in a mounted state, are disposed in the recesses 172c of the radial extensions 94c, 96c, 98c. The guide extensions 176c, 178c, 180c are realized in the form of pins. It is conceivable for the guide extensions 176c, 178c, 180c to be integral with the rolling elements 18c, 20c, 22c. In the case of a motion by the actuating elements 54c, 56c, 58c, the rolling elements 18c, 20c, 22c are moved in the direction of the driving faces 158c, 160c, 162c, contrary to a spring force of the positioning springs 170c. In respect of a further mode of functioning of the braking unit 14c and output unit 60c, reference may be made to the description of FIGS. 1 to 8.

1. A power-tool braking device of a portable power tool, comprising:
at least one braking unit configured to brake a motion of a working tool, at least in one operating mode,
wherein the at least one braking unit includes at least one rolling element configured to activate at least one braking mode of the at least one braking unit.

2. The power-tool braking device as claimed in claim 1, wherein the at least one braking unit further includes at least one driver element configured to move at least one frictional element of the at least one braking unit, at least in the at least one braking mode, via a combined action with the at least one rolling element.

3. The power-tool braking device as claimed in claim 2, wherein the at least one frictional element is at least partially surrounded, along a circumferential direction, by at least one braking element of the at least one braking unit.

4. The power-tool braking device as claimed in claim 2, wherein the at least one driver element has at least one clamping contour configured to clamp-in the at least one rolling element between the at least one frictional element and the at least one driver element, at least in the at least one braking mode.

5. The power-tool braking device as claimed in claim 4, wherein the at least one clamping contour is configured as a ramp.

6. The power-tool braking device as claimed in claim 2, wherein the at least one frictional element has a frictional extension configured to be disposed at least partially along an axial direction between at least two braking elements of the at least one braking unit when in a mounted state.

7. The power-tool braking device as claimed in claim 2, wherein the at least one braking unit has at least one spring element configured to bias at least one braking element of the at least one braking unit in a direction of the at least one frictional element.

8. The power-tool braking device as claimed in claim 1, wherein the at least one braking unit has at least one actuating element configured to move the at least one rolling element as a result of a relative motion between the at least one actuating element and a driver element of the at least one braking unit, at least in one operating mode.

9. The power-tool braking device as claimed in claim 8, further comprising:
at least one output unit including at least one output element to which the at least one actuating element is connected in a rotationally fixed manner.

10. A portable power tool, comprising:
a power-tool braking device, including:
at least one braking unit configured to brake a motion of a working tool, at least in one operating mode,
wherein the at least one braking unit includes at least one rolling element configured to activate at least one braking mode of the at least one braking unit.

11. The power-tool braking device as claimed in claim 1, wherein the power-tool braking device is a hand-held power-tool braking device.

12. The portable power tool as claimed in claim 10, wherein the portable power tool is a hand-held power tool.
